(19) United States
(12) Patent Application Publication
(10) Pub. No.: US 2026/0302783 A1
(43) Pub. Date: Oct. 1, 2026

(54) METHODS OF OPERATING AN ENERGY STORAGE SYSTEM

(71) Applicant: KRAKEN TECHNOLOGIES LIMITED, London (GB)

(72) Inventors: Steve WATTAM, Yorkshire (GB); Mike LOWE, Merseyside (GB)

(73) Assignee: KRAKEN TECHNOLOGIES LIMITED, London (GB)

(21) Appl. No.: 18/996,322

(22) PCT Filed: Jun. 23, 2023
(86) PCT No.: PCT/GB2023/051649

§ 371 Date: Jan. 17, 2025

(30) Foreign Application Priority Data
Jul. 18, 2022 (GB) 2210517.5

(51) Int. Cl. H02J 3/28; H02J 3/00; H02J 3/0014; H02J 7/82; H02J 7/90; H02J 103/30; H02J 103/40

(52) U.S. Cl. CPC H02J 3/28; H02J 3/00142; H02J 3/003; H02J 7/82; H02J 7/933; H02J 2103/30; H02J 2103/40

(57) ABSTRACT

A method of operating an energy storage system arranged to supply power to a power grid at a time tb over a predetermined operation time window(POTW) includes determining a current state of charge, SoC, at a time t0; estimating a total energy usage between t0 and tb; determining a forecast SoC at tb based on the current SoC and the estimated total energy usage; inputting the forecast SoC, an operation constraint, and a system parameter specific to the energy storage system into an optimization algorithm. The operation constraint is an operation condition met by the system during the POTW. The method further includes determining power values, each decomposed into an integer component and a float component, corresponding to a time step during the POTW using the optimization algorithm, and selecting a power value with a zero float component to form an operation baseline for the POTW.

### CROSS-REFERENCE TO RELATED APPLICATIONS

This application is a national phase application of International Application No. PCT/GB2023/051649, filed Jun. 23, 2023, which claims priority to Great Britian Application No. 2210517.5, filed Jul. 18, 2022, all of which are incorporated herein by reference.

### BACKGROUND

The present technology relates to methods of operating energy storage systems and energy storage systems for implementing the methods.

Frequency response services seek to correct for imbalance between generation and demand on a power grid in real time. For example, frequency response services may respond to an increase in AC (alternating current) frequency, which indicates an over-generation of electricity, by either increasing demands on electricity or reducing its generation, and respond to a decrease in AC frequency, which indicates an under-generation of electricity, by reducing demands on electricity or increasing its generation. In practice, the actual speed and magnitude of such a response varies by service.

An approach of frequency response services in the UK is the Dynamic Containment service (DC), which takes into account energy storage (battery), in addition to energy generation, systems for energy provision. The service allows for the specification of a “baseline” in advance of an energy storage system providing a frequency response service. A baseline is a power level set for an energy storage system that is applied on top of power delivery service, and describes the rate of energy being imported or exported (positive or negative power) over time while the energy storage system is providing a frequency response service. Varying the baseline allows an operator of the energy storage system to manage the state-of-charge of the energy storage system, to buy or to sell power on a different market without interrupting provision of a frequency response service.

When providing frequency response, an energy storage system is required to deliver power at a predetermined rate. In general, provision of service is determined in response to real-time system events, such as a request by the system operator or changes in generation or consumption balance, as well as market prices. Thus, calculation of a baseline for an energy storage system has many challenges arising from a number of conflicting objectives, for example:
State-of-charge (SoC) management;
Ability to dispatch power to power markets on-demand;
Conformance with a set of frequency response service rules (such as ramp rate limits, min/max response speeds).

While control loops may be used to correct for SoC imbalances, approaches without adequate optimisation is insufficient to accurately determine a baseline for an energy storage device due to various constraints arising from device limits such as power and response speed, and service requirements such as ramp rate, smooth delivery of power when joining onto other services, and possible simultaneous operation of one service with another. If these constraints are not addressed, the device could be damaged by imprecise control, service provided by the device could be disrupted, or energy of the device may be used sub-optimally leading to higher costs.

One approach of SoC balancing is to use numerical approximation or gradient descent. Another approach uses complex and non-generalisable geometric methods, which analytically calculates the power required. This approach however requires significant re-engineering when changes, even small changes, are made to the service or device details.

It is therefore desirable to provide improved methods of operating energy storage systems.

### SUMMARY

In view of the foregoing, the present technology provides a method of operating an energy storage system, the energy storage system being arranged to supply power to a power grid at a time tb over a predetermined operation time window, the method comprising: determining a current state of charge, SoC, of the energy storage system at a time t0; estimating a total energy usage by the energy storage system between the time t0 and the time tb; determining a forecast SoC of the energy storage system at the time tb based on the current SoC and the estimated total energy usage; inputting the forecast SoC, at least one operation constraint and one or more system parameters to an optimisation algorithm, the at least one operation constraint being an operation condition to be met by the energy storage system during the predetermined operation time window, and the one or more system parameters being parameters specific to the energy storage system; determining a plurality of power values each corresponding to a time step during the predetermined operation time window using the optimisation algorithm, wherein each power value is decomposed into an integer component and a float component; and selecting one or more power values from the plurality of power values with a zero float component to form an operation baseline at which the energy storage system is to be operated during the predetermined operation time window.

In order to ensure continued operation and the overall efficiency of service provision, it is important to provide effective SoC balancing for the stability of an energy storage system while it is providing energy services. Setting a baseline for the energy storage system ahead of energy provision ensures continuation of service. Varying the baseline allows an operator of the energy storage system to manage the SoC of the energy storage system, so as to enable the energy storage system to import or to export power without interrupting service provision. When determining a baseline, the power values specified in the baseline must be integer values (e.g. in megawatts MW) aligned to specified timesteps (e.g. one or multiple minutes). According to embodiments of the present technology, a plurality of power values is determined using an optimisation algorithm based on a forecast SoC, at least one operation constraint and one or more parameters that represent the energy storage system, where each power value corresponds to a time step during a predetermined operation time window, and each power value is decomposed into an integer component and a float component, then one or more power values from the plurality of power values with a zero float component are selected to form an operation baseline. Embodiments of the present technology is therefore able to determine a baseline for the operation of an energy storage system with improved accuracy and with only integer values. The present technology thus enables energy services by energy storage systems/devices to be provided smoothly with little to no interruption, thereby improving the overall efficiency of the operation of the power grid or electricity provision system.

In some embodiments, the method may further comprise determining an average energy usage by the energy storage system at the time t0.

In some embodiments, the total energy usage by the energy storage system between the time t0 and the time tb may be estimated based on the average energy usage.

In some embodiments, the method may further comprise measuring an amount of energy usage during a time period preceding the time t0.

In some embodiments, the total energy usage by the energy storage system between the time t0 and the time tb may be estimated based on the amount of energy usage during the time period preceding the time t0.

In some embodiments, the time period preceding the time t0 may be a time period immediately preceding the time t0 or any time period preceding the time t0, and the time period preceding the time t0 may be one hour or multiples of one hour.

In some embodiments, the one or more system parameters may comprise one or more of: a storage capacity of the energy storage system, a minimum SoC, a maximum SoC, a minimum power, a maximum power, a relationship between the energy storage system SoC and power.

In some embodiments, the minimum SoC may be 5% and the maximum SoC may be 95%.

In some embodiments, the at least one operation constraint may comprise one or more of: a target power at a predetermined time within the predetermined operation time window, a minimum power at the time tb, a maximum power at the time tb, a minimum power at an end time of the predetermined operation time window, a maximum power at an end time of the predetermined operation time window.

In some embodiments, the one or more power values may be selected from the plurality of power values based on the energy storage system operating under one or more criteria.

In some embodiments, the one or more criteria may comprise: meeting a target amount of energy supplied over the predetermined operation time window, meeting a target amount of energy received over the predetermined operation time window, operating below a maximum rate of change of power, a power at which the energy storage system operate does not change from negative to positive or positive to negative within a single time step.

In some embodiments, the method may further comprise operating the energy storage system according to the operation baseline during the predetermined operation time window.

In some embodiments, the method may further comprise operating the energy storage system according to the operation baseline in addition to providing a frequency response service during the predetermined operation time window.

In some embodiments, the predetermined operation time window may comprise a plurality of time steps, each time step corresponding to one minute, two minutes, three minutes, four minutes, five minutes, or multiples of one minute.

In some embodiments, the optimisation algorithm may be a mixed integer linear programming algorithm.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Embodiments will now be described, with reference to the accompanying drawings, in which:

FIG. 1 shows an exemplary method of operating an energy storage system using a baseline;

FIG. 2 shows schematically an exemplary baseline for operating an energy storage system;

FIG. 3 illustrates determination of a baseline according to an embodiment;

FIG. 4A shows an exemplary baseline determined as illustrated by FIG. 3; and

FIG. 4B shows the baseline of FIG. 4A showing only vertices.

### DETAILED DESCRIPTION

Effective state-of-charge balancing is important for the stability of an energy storage system while it is providing energy services in order to ensure uninterrupted operation. A baseline may be set for the energy storage system ahead of energy provision and submitted to the grid, setting the power imported or exported by the energy storage system during service. Varying the baseline therefore allows an operator of the energy storage system to manage the SoC of the energy storage system. Power values specified in the baseline are required to be integer values (e.g. in megawatts MW) that are aligned to specified timesteps (e.g. one or multiple minutes). Embodiments of the present technology determine a plurality of power values by applying an optimisation algorithm using a forecast SoC, at least one operation constraint and one or more parameters that represent the energy storage system, where each power value is decomposed into an integer component and a float component, then one or more power values from the plurality of power values with a zero float component are selected to form an operation baseline. In doing so, embodiments of the present technology is able to determine a baseline for the operation of an energy storage system with only integer values and with improved accuracy. The present technology thus enables energy storage systems/devices to provide energy services smoothly with little to no interruption, thereby improving the overall efficiency of the operation of the power grid.

According to present embodiments, baselines for energy storage systems are submitted by respective operators to the grid prior to the baselines becoming active, i.e. before the energy storage systems start providing energy service. The mechanism used to notify the grid can vary depending on specific energy storage system and the service it provides, and the period for which a baseline specifies can vary. For example, this period may be 30 minutes, an hour, more than an hour, etc.

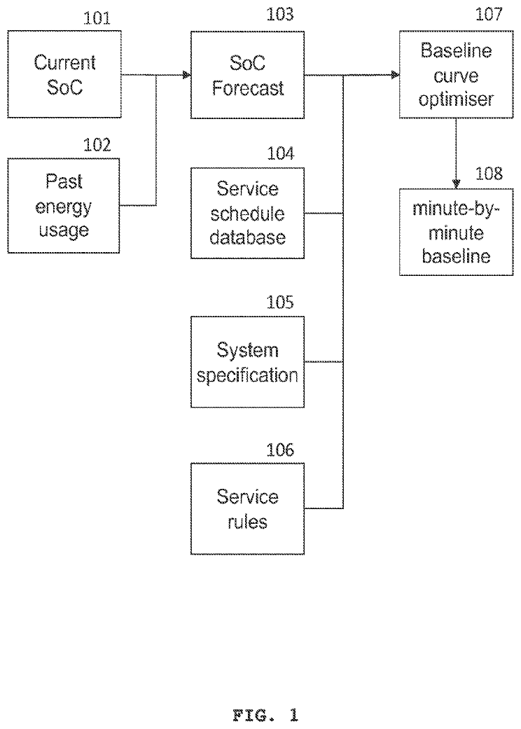

An embodiment of a method of operating an energy storage system (e.g. a battery for storing renewal energy, a battery from an electric car, etc.) for energy provision using a baseline is shown in FIG. 1. The method may be implemented as software, hardware or a combination of both. According to the present embodiment, energy usage (e.g. a volume of energy that has been used) in a time period preceding a current time t0 is recorded at 102. The preceding time period may be a time period immediately preceding the time t0, or it may be any time period preceding to. Any suitable length of time period may be used as desired, for example 30 minutes, one hour, multiple hours, etc. By obtaining the current state of charge of the energy storage system at 101, the recorded past energy usage may be used to forecast an energy usage between the current time, to, and a time tb when the baseline becomes active over a predetermined operation time window. The predetermined operation time window may be any suitable time period, e.g. 30 minutes, one hour, multiple hours, etc., as desired by the operator of the energy storage system and/or in accordance with agreements with an operator of the grid.

For the energy storage system to remain in operation, it is necessary to maintain its state-of-charge between ~5% and ~95%. When the energy storage system is operating, e.g. during the predetermined operation time window, its SoC would fluctuate depending on whether the energy storage system is importing or exporting energy and the rate at which it does so. As such, a robust and accurate baseline is desirable to enable the energy storage system to provide uninterrupted service while participating in other energy markets. Control of the energy storage system, e.g. to determine a suitable baseline and to operate the energy storage system according to the determined baseline, may be performed by a control system. The control system may be integrated into the energy storage system, or it may be a control system independent of the energy storage system and communicate to the energy storage system via a suitable communication channel. The control system may be specific to the energy storage system, or it may be arranged to communicate with multiple energy storage systems and operate the multiple energy storage systems simultaneously.

In the present embodiment, the control system obtains at the current time to the current SoC of the energy storage system at 101. In addition, the control system records the energy usage by the energy storage system over a time period preceding the current time t0. The control system is configured with a definition for determining the SoC of the energy storage system in order to operate the energy storage system at a given power. Using the recorded past energy usage and the current SoC at to, the control system forecasts at 103 the energy usage between the current time t0 and the time tb when the baseline becomes active and computes a target power at which the energy storage system operates at each given time period while maintaining the SoC of the energy storage system within the normal operation range. The target power is dependent on the current SoC.

Upon determining the forecasted energy usage (or forecasted SoC), the control system identifies one or more operation constraints (104) that may affect the baseline. For example, contractual obligations to deliver a set power at a set time, or ending service at a given power to enable smooth transition to the next service. In the present example, these operation constraints can be identified from a service schedule database 104 obtained from the operator of the grid.

The identified operation constraints are then entered into an optimisation routine (algorithm), along with a set of system specification 105 defining parameters specific to the energy storage system that describes the behaviour of the energy storage system, and limits applied by the grid operator based on service rules 106 (e.g. restriction on power fluctuations faster than a rate limit (ramp rage)).

In the present embodiment, a mixed-integer-linear-programming (MILP) approach is used in the optimisation routine. Other approaches are possible. Using a MILP approach, the control system enters the SoC forecast, the identified operation constraints, the system parameters, and any specific limits based on service rules into a baseline curve optimiser 107 to determine a plurality of power values for operating the energy storage device during the predetermined operation time window, and outputs a minute-by-minute baseline at 108.

By identifying operation constraints and system parameters, the resulting baseline enables the energy storage system to operate in such a way that, e.g.:
a specific energy import or export is reached during the optimisation window;
a specific start power and a specific end power are met;
a rate of change of power does not exceeds a rate threshold (note that there may be different limits for import and export);
operating power at any given time does not change from positive to negative or vice versa within a single time step (i.e. no spikes).

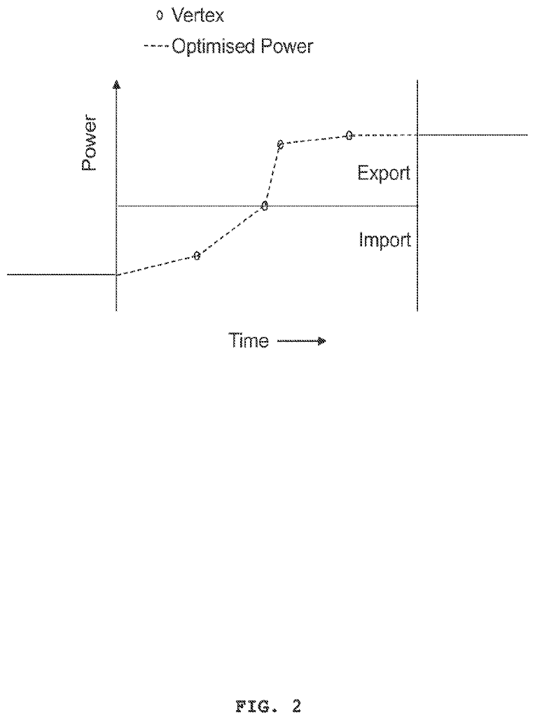

FIG. 2 shows a schematic example of a baseline, which defines for the energy storage system the power at which it operates at a given time. Positive power values represent export of energy by the energy storage system while negative values represent import of energy.

A baseline specifies the power at which the energy storage system operates at a given time step. In order for a power value to be used in a baseline, the power value must be an integer value (e.g. in MW) and aligned with a time step (e.g. a minute step). Thus, baseline optimisation, e.g. baseline curve optimiser 107, is configured to output a plurality of power values corresponding to a time (e.g. per minute), and to select one or more integer power values that correspond to integer time (e.g. at the minute).

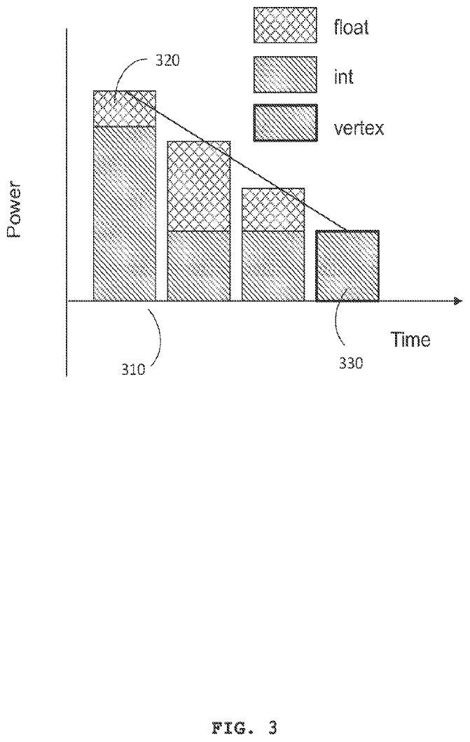

FIG. 3 illustrates an approach of the present technology wherein a plurality of power values is determined during baseline optimisation. In the present approach, a power value is output as or decomposed into two components—an integer component 310 and a float component 320. A time step where the float component of the power value is 0 is referred to as a vertex 330. Additional rules may be programmed into the baseline optimisation algorithm to restrict vertices from being too close in time, and mandate monotonic ramps.

In some embodiments, the optimisation algorithm may be configured with preference towards simpler baseline curves with shallow ramps. By biasing the optimisation algorithm towards simpler baseline curves, an energy storage system can follow a resulting baseline more accurately.

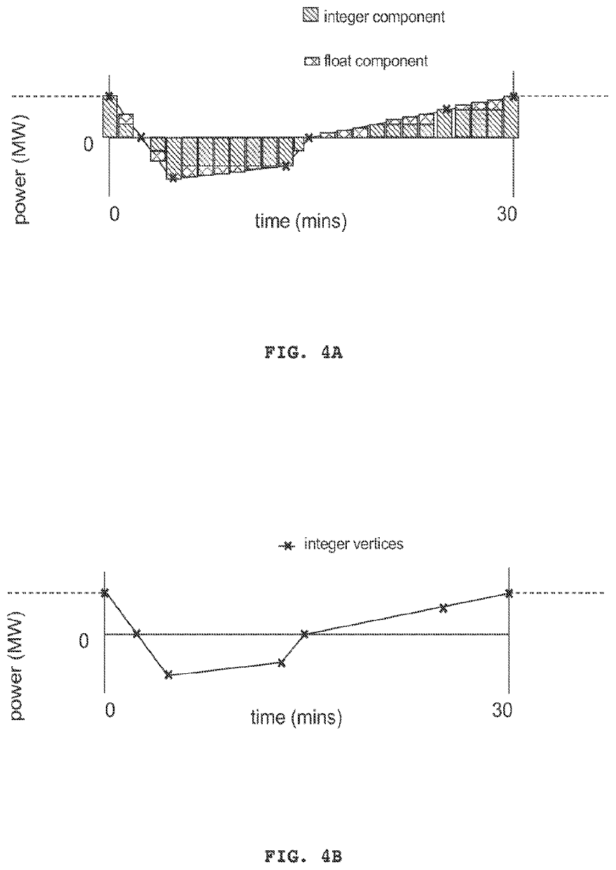

An example of baseline optimisation is shown in FIG. 4A. As can be seen, a plurality of power values, including positive power values and negative power values, are determined by the baseline optimisation algorithm for each time step and each power value is output as an integer component and a float component. Power values with a zero float component, indicated with a “x”, are selected as vertices.

FIG. 4B shows a baseline generated from the power values of FIG. 4A. Through the present baseline optimisation routine, the power values specified in the baseline of FIG. 4B all have integer values and aligned with a time step.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

1. A method of operating an energy storage system, the energy storage system being arranged to supply power to a power grid at a time tb over a predetermined operation time window, the method comprising:
determining a current state of charge, SoC, of the energy storage system at a time t0;
estimating a total energy usage by the energy storage system between the time t0 and the time tb;
determining a forecast SoC of the energy storage system at the time tb based on the current SoC and the estimated total energy usage;
inputting the forecast SoC, at least one operation constraint and one or more system parameters to an optimisation algorithm, the at least one operation constraint being an operation condition to be met by the energy storage system during the predetermined operation time window, and the one or more system parameters being parameters specific to the energy storage system;
determining a plurality of power values each corresponding to a time step during the predetermined operation time window using the optimisation algorithm, wherein each power value is decomposed into an integer component and a float component; and
selecting one or more power values from the plurality of power values with a zero float component to form an operation baseline at which the energy storage system is to be operated during the predetermined operation time window.

2. The method of claim 1, further comprising determining an average energy usage by the energy storage system at the time t0.

3. The method of claim 2, wherein the total energy usage by the energy storage system between the time t0 and the time tb is estimated based on the average energy usage.

4. The method of claim 1, further comprising measuring an amount of energy usage during a time period preceding the time t0.

5. The method of claim 4, wherein the total energy usage by the energy storage system between the time t0 and the time tb is estimated based on the amount of energy usage during the time period preceding the time t0.

6. The method of claim 4, wherein the time period preceding the time t0 is a time period immediately preceding the time t0 or any time period preceding the time t0, and wherein the time period preceding the time t0 is one hour or multiples of one hour.

7. The method of claim 1, wherein the one or more system parameters comprise one or more of: a storage capacity of the energy storage system, a minimum SoC, a maximum SoC, a minimum power, a maximum power, a relationship between the energy storage system SoC and power.

8. The method of claim 7, wherein the minimum SoC is 5% and wherein the maximum SoC is 95%.

9. The method of claim 1, wherein the at least one operation constraint comprises one or more of: a target power at a predetermined time within the predetermined operation time window, a minimum power at the time tb, a maximum power at the time tb, a minimum power at an end time of the predetermined operation time window, a maximum power at an end time of the predetermined operation time window.

10. The method of claim 1, wherein the one or more power values are selected from the plurality of power values based on the energy storage system operating under one or more criteria.

11. The method of claim 10, wherein the one or more criteria comprise:
meeting a target amount of energy supplied over the predetermined operation time window, meeting a target amount of energy received over the predetermined operation time window, operating below a maximum rate of change of power, a power at which the energy storage system operate does not change from negative to positive or positive to negative within a single time step.

12. The method of claim 1, further comprising operating the energy storage system according to the operation baseline during the predetermined operation time window.

13. The method of claim 1, further comprising operating the energy storage system according to the operation baseline in addition to providing a frequency response service during the predetermined operation time window.

14. The method of claim 1, wherein the predetermined operation time window comprises a plurality of time steps, each time step corresponding to one minute, two minutes, three minutes, four minutes, five minutes, or multiples of one minute.

15. The method of claim 1, wherein the optimisation algorithm is a mixed integer linear programming algorithm.

16. An apparatus for controlling operation of an energy storage system, the energy storage system being arranged to supply power to a power grid at a time tb over a predetermined operation time window, the apparatus comprising:
communication circuitry
at least one processor; and
a non-transitory computer-readable medium having stored thereon software instructions that, when executed by the at least one processor, cause the apparatus to:
determine a current state of charge, SoC, of the energy storage system at a time t0;
estimate a total energy usage by the energy storage system between the time t0 and the time tb;
determine a forecast SoC of the energy storage system at the time tb based on the current SoC and the estimated total energy usage;
input the forecast SoC, at least one operation constraint and one or more system parameters to an optimisation algorithm, the at least one operation constraint being an operation condition to be met by the energy storage system during the predetermined operation time window, and the one or more system parameters being parameters specific to the energy storage system;
determine a plurality of power values each corresponding to a time step during the predetermined operation time window using the optimisation algorithm, wherein each power value is decomposed into an integer component and a float component; and
select one or more power values from the plurality of power values with a zero float component to form an operation baseline at which the energy storage system is to be operated during the predetermined operation time window.

17. The apparatus of claim 16, wherein the instructions further cause the apparatus to determine an average energy usage by the energy storage system at the time t0, wherein the total energy usage by the energy storage system between the time t0 and the time tb is estimated based on the average energy usage.

18. The apparatus of claim 16, wherein the instructions further cause the apparatus to measure an amount of energy usage during a time period preceding the time t0, wherein the total energy usage by the energy storage system between the time to and the time tb is estimated based on the amount of energy usage during the time period preceding the time t0.

19. The apparatus of claim 16, wherein the one or more system parameters comprise one or more of: a storage capacity of the energy storage system, a minimum SoC, a maximum SoC, a minimum power, a maximum power, a relationship between the energy storage system SoC and power.

20. The apparatus of claim 16, wherein the at least one operation constraint comprises one or more of: a target power at a predetermined time within the predetermined operation time window, a minimum power at the time tb, a maximum power at the time tb, a minimum power at an end time of the predetermined operation time window, a maximum power at an end time of the predetermined operation time window.
